(19) United States
(12) Patent Application Publication
(10) Pub. No.: US 2008/0285994 A1
(43) Pub. Date: Nov. 20, 2008

(54) Image forming apparatus and control device

(75) Inventor: Yoshiaki Tamura, Osaka-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION

(21) Appl. No.: 11/984,653

(22) Filed: Nov. 20, 2007

(30) Foreign Application Priority Data
Nov. 24, 2006 (JP) 2006-316681

(51) Int. Cl. G03G 15/16

(52) U.S. Cl. 399/66

(57) ABSTRACT

A low cost image forming apparatus capable of detecting a moving speed or meandering of a revolving endless belt with high accuracy to thereby prevent the color shift includes: a revolving endless belt sequentially superimposing and transferring toner images formed on a plurality of photoconductive drums directly thereon or onto a recording sheet conveyed thereby; an emission part irradiating light to the endless belt; an image receiving part receiving light reflected on the endless belt to obtain successive images of the endless belt; and a control part comparing the successive images obtained by the image receiving part with one another, calculating either of a moving speed and an amount of meandering of the endless belt, and correcting either of the moving speed and the meandering of the endless belt based on a result of the calculation.

This application is based on Japanese Patent Application No. 2006-316681 filed on Nov. 24, 2006, the contents of which are hereby incorporated by reference.

### BACKGROUND OF THE INVENTION

1. Field of the Invention

The present invention relates to an image forming apparatus provided with an endless belt revolving in such a manner as to oppose a plurality of photoconductive drums. The present invention also relates to a control device that controls speed or meandering of a revolving, endless object to be measured.

2. Description of Related Art

A conventional image forming apparatus is disclosed in JP-A-2001-083761. This image forming apparatus includes a plurality of photoconductive drums, and an intermediate transfer body formed of an endless belt revolving in such a manner as to oppose the plurality of photoconductive drums. Toner images formed on the respective photoconductive drums are superimposed on one another and transferred onto the intermediate transfer body. The toner images of a plurality of different colors formed on the intermediate transfer body are transferred onto a recording sheet to form an image on the recording sheet.

The intermediate transfer body is stretched and revolves around a driving roller, which is provided with a rotary encoder. By measuring a rotation angle of the driving roller within a predetermined period with the rotary encoder, moving speed of the intermediate transfer body is detected. When the moving speed of the intermediate transfer body deviates from a predetermined range, traveling of the intermediate transfer body is controlled so that it falls within the predetermined range. As a result, color shift in a circumferential direction of the intermediate transfer body upon superimposing a plurality of colors can be prevented.

Another image forming apparatus is disclosed in JP-A-H5-127542. This image forming apparatus has a light emission part which is provided above a side end surface of an intermediate transfer body and a light receiving part which is provided therebelow. When the intermediate transfer body revolves and meanders, a range of light blocked by the intermediate transfer body varies, so that an amount of light received at the light receiving part varies. Therefore, by monitoring the amount of light received at the light receiving part, an amount of meandering of the intermediate transfer body is detected. When the amount of meandering of the intermediate transfer body deviates from a predetermined range, traveling of the intermediate transfer body is controlled so that it falls within the predetermined range. As a result, the color shift in a direction perpendicular to the circumferential direction upon superimposing a plurality of colors can be prevented.

However, with the former image forming apparatus, when slipping occurs between the intermediate transfer body and the driving roller, the moving speed of the intermediate transfer body is erroneously detected. Moreover, when the intermediate transfer body and the driving roller wear due to a sliding therebetween, a difference arises between the moving speed obtained from the rotation angle of the driving roller and an actual moving speed. With these circumstances, the accuracy in detecting the moving speed of the intermediate transfer body deteriorates. Thus, there has arisen a problem that the moving speed of the intermediate transfer body cannot be controlled with high accuracy, thus resulting in failure to satisfactorily prevent the color shift in the circumferential direction.

With the latter image forming apparatus, the light blocked by the intermediate transfer body undergoes diffraction on the side end surface of the intermediate transfer body and thus scatters. In addition, depending on the irregularity of the side end surface of the intermediate transfer body, the amount of light received at the light receiving part varies. With these circumstances, there has also arisen a problem that meandering of the intermediate transfer body cannot be detected with high accuracy, thus resulting in failure to satisfactorily prevent the color shift in the direction perpendicular to the circumferential direction.

Further, to prevent the color shift in the circumferential direction of the intermediate transfer body and the color shift in the direction perpendicular to the circumferential direction, a moving speed detector and a meandering detector need to be provided. Therefore, there has arisen a problem that cost of the image forming apparatus increases.

The same problem arises in an image forming apparatus that conveys a recording sheet by an endless belt revolving in such a manner as to oppose a photoconductive drum and then transfers a toner image onto the recording sheet directly from the photoconductive drum.

### SUMMARY OF THE INVENTION

It is an object of the present invention to provide an image forming apparatus which is capable of detecting the moving speed or meandering of a revolving endless belt with high accuracy, and thereby which can prevent the color shift while permitting cost reduction. It is another object of the present invention to provide a control device which is capable of detecting the moving speed or meandering of the revolving endless belt with high accuracy.

To achieve the object described above, an image forming apparatus according to a first aspect of the present invention is characterized by including: a revolving endless belt sequentially superimposing and transferring toner images formed on a plurality of photoconductive drums directly thereon or onto a recording sheet conveyed thereby; an emission part irradiating light to the endless belt; an image receiving part receiving light reflected on the endless belt to obtain successive images of the endless belt; and a control part comparing the successive images obtained by the image receiving part with one another, calculating either of a moving speed and an amount of meandering of the endless belt, and correcting either of the moving speed and the meandering of the endless belt based on a result of the calculation.

According to this configuration, onto the recording sheet conveyed to an intermediate transfer body formed of the endless belt making revolving movement and an endless belt, toner images of different colors, including yellow, magenta, cyan, black, and the like, visualized on the photoconductive drums are sequentially transferred. The light emission part irradiates light, such as infrared laser light, visible light, or the like, toward the endless belt, and the light reflected on the endless belt enters the light receiving part. The image receiving part is formed of a CCD or the like, and successively obtains images of the endless belt. An image with slight irregularity or scratch in a surface of the endless belt may be obtained by the image receiving part. Moreover, a pattern may be formed on the endless belt with the irregularity, the toner images, or the like, and then an image of this pattern may be obtained. The control part compares the successive images obtained by the image receiving part, and calculates amount of displacement in a circumferential direction of the endless belt and in a direction perpendicular to the circumferential direction. As a result, moving speed or amount of meandering of the endless belt is obtained, and corrected by the control part based on a result of the calculation.

As a result, either of the moving speed and the amount of meandering of the endless belt can be detected with high accuracy. Therefore, the color shift in the circumferential direction of the endless belt and in the direction perpendicular to the circumferential direction can be reliably prevented. Moreover, since either of the moving speed and the amount of meandering of the endless belt can be detected with one detection unit having the emission part and the image receiving part, the cost of the image forming apparatus can be reduced.

In the image forming apparatus with the configuration described above, the light emitted by the emission part is laser light. As a result, a high resolution image can be obtained by the image receiving part. Therefore, either of the moving speed and the amount of meandering of the endless belt can be detected with high accuracy.

In the image forming apparatus with the configuration described above, a storage part is provided which stores an amount of meandering accumulated from a reference time at which the endless belt is adjusted into a non meandering state, wherein, when the accumulated amount of meandering exceeds a predetermined value, the meandering of the endless belt is corrected.

According to this configuration, traveling of the endless belt is adjusted into a non meandering state when the image forming apparatus is manufactured. With this point in time as a reference, the amount of meandering calculated by the control part is accumulated every time the endless belt is driven. When the accumulated amount of meandering stored in the storage part exceeds the predetermined range, the traveling of the endless belt is controlled by the control part so as to correct the meandering of the endless belt. As a result, an image forming apparatus can easily be realized which can prevent the color shift in the direction perpendicular to the circumferential direction of the endless belt.

In the image forming apparatus with the configuration described above, a rear surface of the endless belt is irradiated with light by the emission light, and the successive images of the rear surface of the endless belt are obtained by the image receiving part. As a result, the successive images can be easily compared with one another. Therefore, even in a case where it is difficult to compare the successive images with one another since the surface of the endless belt is formed of a gross surface, the moving speed or the meandering can be detected easily.

A control device according to another aspect of the present invention is characterized by including: an emission part emitting light to a revolving endless object to be measured; an image receiving part receiving light reflected on the object to be measured to obtain successive images of the object to be measured; and a control part comparing the successive images obtained by the image receiving part with one another, calculating either of a moving speed and an amount of the meandering of the object to be measured, and correcting either of the moving speed and the meandering of the object to be measured based on a result of the calculation.

The control device according to another aspect of the present invention is characterized by a structure in which the light emitted by the emission part is laser light in the control device with the configuration described above.

The image forming apparatus according to another aspect of the present invention is characterized by including a storage part storing an amount of meandering accumulated from a reference time at which the endless belt is adjusted into a non meandering state, and by a structure in that meandering of the endless belt is corrected when the accumulated amount of meandering exceeds a predetermined range in the control device with the configuration described above.

### BRIEF DESCRIPTION OF THE DRAWINGS

FIG. 1 is an elevation view to show a schematic configuration of an image forming apparatus according to an embodiment of the present invention;

FIG. 2 is an elevation view to show details of an image formation part of the image forming apparatus according to the embodiment of the present invention;

FIG. 3 is an elevation view to show a travel detection unit of the image forming apparatus according to the embodiment of the present invention;

FIG. 4 is a plan view to show visual fields of an image receiving part on an intermediate transfer body of the image forming apparatus according to the embodiment of the present invention;

FIG. 5 is a block diagram to show a configuration of the image forming apparatus according to the embodiment of the present invention; and

FIG. 6 is a flow chart to show operation for travel adjustment of the image forming apparatus according to the embodiment of the present invention.

### DETAILED DESCRIPTION OF THE PREFERRED EMBODIMENTS

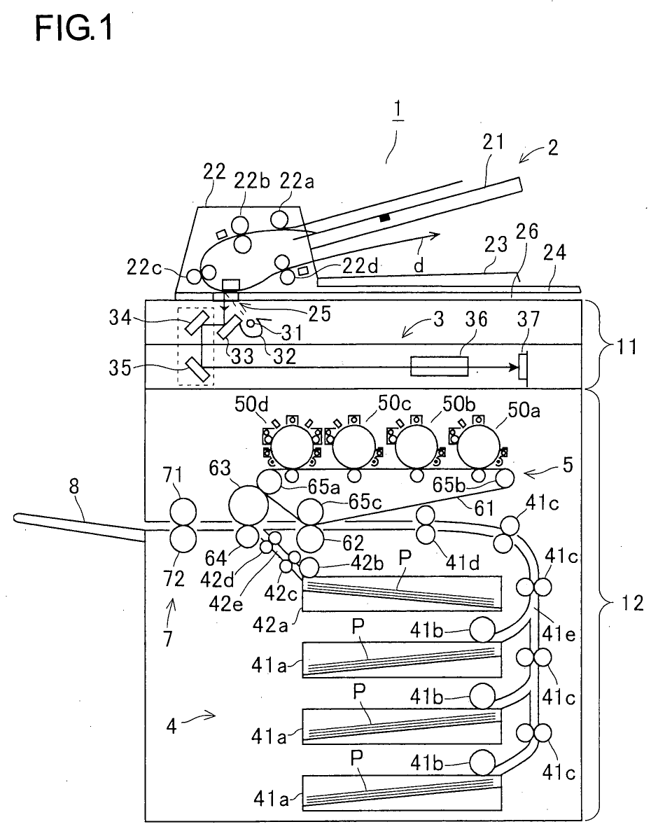

Hereinafter the embodiments of the present invention will be described with reference to the accompanying drawings. FIG. 1 is an elevation view to show a schematic configuration of an image forming apparatus according to a first embodiment. The image forming apparatus 1 is formed of a color copier, and has an upper housing 11 and a lower housing 12. On the upper housing 11, a document conveyance part 2 for conveying a document is mounted in such a manner as to be capable of opening and closing with a support provided at a rear part thereof.

The document conveyance part 2 includes a document feed tray 21, a document conveyance part main body 22, a document discharge tray 23, and a document cover 24. On the document feed tray 21, a document is loaded. The document conveyance part main body 22 conveys the document fed from the document feed tray 21 for scanning. The document discharge tray 23 stores the document discharged from the document conveyance part main body 22. The document cover 24 opens the document conveyance part 2 and holds the document loaded on a document loading plate 26 provided on the top surface of the upper housing 11.

Provided inside the document conveyance part main body 22 are in an order from an upstream side in a document conveyance direction d, a pickup roller 22a, conveyance rollers 22b, 22c, and 22d. The document is taken out from the document feed tray 21 by the pickup roller 22a and conveyed by the conveyance rollers 22b, 22c, and 22d.

Between the conveyance rollers 22c and 22d, an image scanning part 25 is provided. The image scanning part 25 holds, in a certain posture, the document fed from the document feed tray 21, and image scanning is performed by an exposure part 3 provided in the upper housing 11.

The exposure part 3 includes an exposing lamp 31, a reflection plate 32, a first mirror 33, a second mirror 34, a third mirror 35, a condenser lens 36, and an image sensor 37. The exposing lamp 31 emits light, and the light is condensed by the reflection plate 32, then irradiated to the image scanning part 25. The light reflected on the document in the image scanning part 25 are reflected by the first to third mirrors 33 to 35 and then is condensed via the condenser lens 36 onto the image sensor 37 which is formed of, for example, a CCD or the like. As a result, an image on the document fed from the document feed tray 21 is scanned.

The exposing lamp 31, the reflection plate 32, and the first mirror 33 integrally move rightward as viewed in the figure to scan the document loaded on the document loading plate 26. As a result, light reflected on the document on the document loading plate 26 is condensed onto the image sensor 37 whereby the image on the document is read.

Provided inside the lower housing 12 are a paper feed part 4, an image formation part 5, and a fixing unit 7. To the outside of the lower housing 12, a paper discharge tray 8 is fitted. The paper feed part 4 is arranged at the bottom of the lower housing 12 and has a paper feed cassette 42a and a plurality of paper feed cassettes 41a all of which store recording sheets P.

The recording sheet P in the paper feed cassette 41a is conveyed through a recording sheet conveyance path 41e. A recording sheet conveyance path 42e diverges from the recording sheet conveyance path 41e. The recording sheet P on the paper feed cassette 42a, after conveyed through the recording sheet conveyance path 42e, is conveyed through the recording sheet conveyance path 41e. The recording sheet P conveyed through the recording sheet conveyance path 41e is guided to the paper discharge tray 8 from a discharge end of the recording sheet conveyance path 41e.

The recording sheet conveyance path 41e diverges in correspondence with the different paper feed cassettes 41a, and each recording sheet conveyance paths 41e is provided with a pickup roller 41b and a conveyance roller 41c. On the merged recording sheet conveyance path 41e, a conveyance roller 41d is provided. The recording paper conveyance path 42e is provided with a pickup roller 42b and conveyance rollers 42c and 42d.

The recording sheets P is taken out from each of the paper feed cassettes 41a by the pickup roller 41b and conveyed by the conveyance rollers 41c and 41d. In addition, the recording sheet P is taken out from the paper feed cassette 42a by the pickup roller 42b and conveyed by the conveyance rollers 42c and 42d.

The image formation part 5 is disposed above the recording sheet conveyance path 41e. The image formation part 5 forms toner images of four colors including yellow, magenta, cyan, and black by superimposing them on one another on the recording sheet P conveyed through the recording paper conveyance path 41e or recording paper conveyance path 42e. In this embodiment, four toner images are transferred onto the recording sheet, but the same configuration is applicable to a case where two or more colors are used. The fixing unit 7 is disposed at a subsequent stage of the image formation part 5. The fixing unit 7 fixes, with heat, toner images formed on the recording sheet P by the image formation part 5.

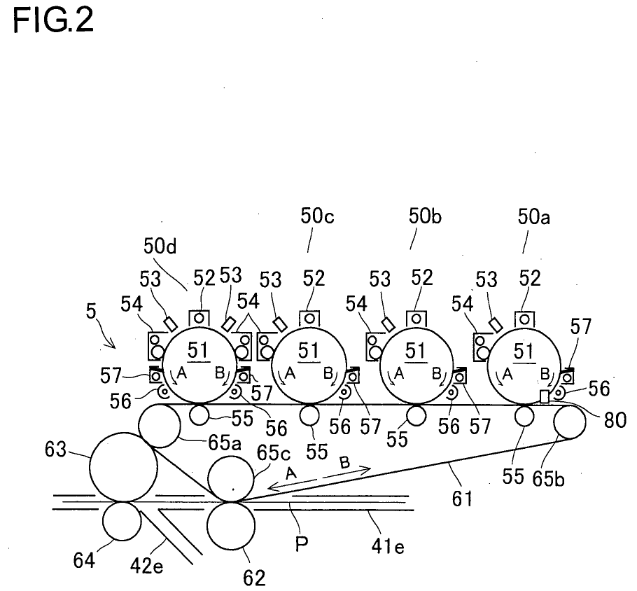

FIG. 2 is an elevation view to show details of the image formation part 5. The image formation part 5 includes image forming units 50a to 50d, intermediate transfer bodies 61 and 63, transfer units 55, 62, and 64, and a travel detection part 80. The intermediate transfer body 61 is formed of an endless belt, and revolves while being spread over and supported by support rollers 65a, 65b, and 65c in a form of an inequilateral triangle. The travel detection part 80, as will be described in detail later, detects the moving speed or the amount of meandering of the intermediate transfer body 61. The intermediate transfer body 63 is formed of a rotary drum, and so arranged to face the support roller 65a with the intermediate transfer body 61 therebetween.

A plurality of transfer units 55 are provided in such a manner as to face respective photoconductive drums 51 which will be described later with the intermediate transfer body 61 therebetween. To the transfer units 55, voltage of a polarity which is opposite to the polarity of the toner charged on the surface of the photoconductive drum 51, is applied. The transfer unit 62 is so arranged as to face the support roller 65c with the recording sheet P passing through the recording sheet conveyance path 41e and the intermediate transfer body 61 therebetween. To the transfer unit 62, voltage of a polarity which is opposite to the polarity of the toner charged on the surface of the intermediate transfer body 61 is applied.

The transfer unit 64 is provided at a subsequent stage of a diverging point of the recording paper conveyance paths 41e and 42e, and so arranged as to face the intermediate transfer body 63 with the recording sheet P passing through the recording paper conveyance path 41e therebetween. To the transfer unit 64, voltage of a polarity which is opposite to the polarity of the toner charged on the surface of the intermediate transfer body 63 is applied. Although not illustrated, near the intermediate transfer body 63, a transfer unit is provided to which voltage of a polarity which is opposite to the polarity of the toner charged on the surface of the intermediate transfer body 61 is applied.

The image forming units 50a to 50d have the same configuration and are in tandem arrangement in contact with the intermediate transfer body 61. By the image forming units 50a to 50d, yellow, magenta, cyan, and black toner images are formed respectively. The black image forming unit 50d is arranged in a side closer to the intermediate transfer body 63. The order of layout in which the yellow, magenta, and cyan image forming units 50a to 50c are arrayed may be changed.

The image forming units 50a to 50d each has the photoconductive drum 51. The image forming units 50a to 50c each has a charger 52, an optical scanning unit 53, a developing unit 54, a static eliminator 56, and a cleaning unit 57, which are arranged counterclockwise around the photoconductive drum 51 as viewed in the figure. Between the developing unit 54 and the static eliminator 56, the photoconductive drum 51 makes contact with the intermediate transfer body 61.

The photoconductive drum 51 rotates counterclockwise (in a direction of arrow A) as viewed in the figure, whereby the charger 52 uniformly charges the photoconductive drum 51. The optical scanning unit 53 emits laser light to erase charges on a surface of the charged photoconductive drum 51 in accordance with image information scanned by the image sensor 37 (see FIG. 1). As a result, an electrostatic latent image is formed on the surface of the photoconductive drum 51.

The developing unit 54 supplies the toner to the electrostatic latent image formed on the photoconductive drum 51 to thereby visualize the latent image as the toner image. This toner image is transferred onto the intermediate transfer body 61 by the transfer unit 55. The static eliminator 56 removes the charges on the surface of the photoconductive drum 51. The cleaning unit 57 is formed of a blade and the like that makes contact with the photoconductive drum 51, and removes residual toner which is not transferred onto the intermediate transfer body 61.

The black image forming unit 50d, as is the case with the image forming units 50a to 50c, is provided with in order counterclockwise from the top as viewed in the figure, a charger 52, an optical scanning unit 53, and a developing unit 54. The black image forming unit 50d is also provided with a static eliminator 56 and a cleaning unit 57 sandwiching a contact portion with the intermediate transfer body 61 therebetween. As a result, the photoconductive drum 51 rotates counterclockwise (in the direction of arrow A) as viewed in the figure, which permits the toner image to be transferred onto the intermediate transfer body 61.

Also provided clockwise from the charger 52 as viewed in the figure are an optical scanning unit 53 and a developing unit 54. A static eliminator 56 and a cleaning unit 57 are also provided which sandwich a contact portion with the intermediate transfer body 61 therebetween. As a result, the photoconductive drum 51 rotates clockwise (in the direction of arrow B) as viewed in the figure, which permits a toner image to be transferred onto the intermediate transfer body 61.

In the image forming apparatus 1 with the configuration described above, when a document is set on the document feed tray 21 or the document loading plate 26, an image formed on the document is scanned by the image sensor 37 of the exposure part 3. The image information scanned is then transmitted to the image formation part 5.

If a color image is formed in the image formation part 5, by driving of the support roller 65b, the intermediate transfer body 61 is rotated in the direction of arrow A in FIG. 2. In addition, the photoconductive drum 51 of each of the image forming units 50a to 50d rotates clockwise (in the direction of arrow A) as viewed in the figure. Upon start of the rotation of the photoconductive drum 51, the chargers 52 uniformly charge the surface of the photoconductive drum 51.

Next, charges corresponding to an image portion formed on the recording sheet P or a non image portion are erased by laser light emitted from the optical scanning unit 53, thereby an electrostatic latent image is formed on the photoconductive drum 51. The electrostatic latent image on the photoconductive drum 51 is supplied with the toner from the developing unit 54 and then visualized as a toner image.

When the photoconductive drum 51 further rotates and the toner image faces the transfer unit 55, voltage of a polarity which is opposite to the polarity of the charges of the toner is applied to the transfer unit 55. This causes the toner image formed on the surface of the photoconductive drum 51 to be transferred onto the intermediate transfer body 61. The electrostatic latent image formed on the photoconductive drum 51 is diselectrified by the static eliminator 56 and the residual toner which is not transferred is removed from the photoconductive drum 51 by the cleaning unit 57.

The respective image forming units 50a to 50d are sequentially driven at predetermined timing, and the toner images including the black toner image are superimposed on one another on the intermediate transfer body 61.

The intermediate transfer body 61 further rotates, and the toner images are disposed at a position facing the transfer unit 62. At this moment, the recording sheet P conveyed through the recording paper conveyance path 41e is disposed between the intermediate transfer body 61 and the transfer unit 62. Voltage of a polarity which is opposite to the polarity of charges of the toner is applied to the transfer unit 62, whereby the toner images formed on the intermediate transfer body 61 are transferred onto the recording sheet P. The residual toner which is not transferred but remaining on the intermediate transfer body 61 is removed from the intermediate transfer body 61 by a cleaning unit (not shown).

The recording sheet P with the toner images transferred thereon is conveyed through the recording paper conveyance path 41e and guided to the fixing unit 7. In the fixing unit 7, the toner images are fixed onto the recording sheet P. The recording sheet P with the images fixed thereon is conveyed through the recording paper conveyance path 41e and then discharged to the paper discharge tray 8.

To form a monochrome image with the image formation part 5, driving of the support roller 65a causes the intermediate transfer body 61 to rotate in the direction of arrow B in FIG. 2. At this moment the photoconductive drums 51 of the yellow, magenta, and cyan image forming units 50a to 50c, in contact with the intermediate transfer body 61, rotate in the direction of arrow B, but does not perform image formation.

In the black image forming unit 50d, the photoconductive drum 51 rotates clockwise (in the direction of arrow B) as viewed in the figure. Then, as described above, a monochrome toner image is formed onto the photoconductive drum 51 and then transferred onto the intermediate transfer body 61. The toner image transferred onto the intermediate transfer body 61 faces the intermediate transfer body 63, upon which the toner image is transferred onto the intermediate transfer body 63 by a transfer unit, not shown.

The intermediate transfer body 63 further rotates, and the toner image transferred onto the intermediate transfer body 63 is disposed at a position facing the transfer unit 64. At this moment, the recording sheet P conveyed through the recording paper conveyance paths 42e and 41e from the paper feed cassette 42a is disposed between the intermediate transfer body 63 and the transfer unit 64. Voltage of a polarity which is opposite to the polarity of charges of the toner is applied to the transfer unit 64, whereby the toner image formed on the intermediate transfer body 63 is transferred onto the recording sheet P. The residual toner which is not transferred but remaining on the intermediate transfer body 63 is removed from the intermediate transfer body 63 by a cleaning unit (not shown).

The recording sheet P with the toner image transferred thereon is conveyed through the recording paper conveyance path 41e and guided to the fixing unit 7. In the fixing unit 7, the toner image is fixed onto the recording sheet P. The recording sheet P with the image fixed thereon is conveyed through the recording paper conveyance path 41e and then discharged to the paper discharge tray 8.

Consequently, in a case where a monochrome image is formed, as compared to a case where a color image is formed, the distance in which the toner image moves from the photoconductive drum 51 until when it is fixed onto the recording sheet P becomes shortened. Therefore, the time until a first image is discharged in the monochrome image formation can be reduced.

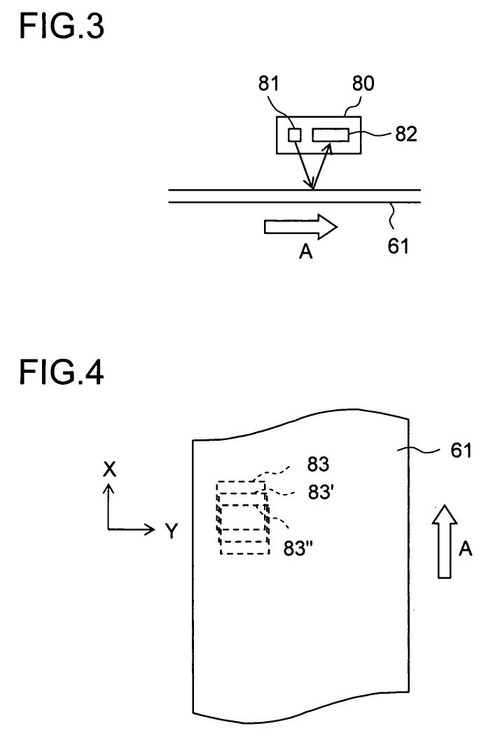

FIG. 3 is an elevation view to show a configuration of a travel detection part 80. The travel detection part 80 includes an emission part 81 and an image receiving part 82, and is disposed above the intermediate transfer body 61. The light emission part 81 is formed of a semiconductor laser, and irradiates the intermediate transfer body 61 with laser light. As the laser light, for example, an infrared laser having a wavelength of 850 nm±20 nm can be used. The image receiving part 82 receives the light emitted from the emission part 81 and then reflected on the intermediate transfer body 61 to obtain an image on the intermediate transfer body 61. The image receiving part 82 is formed of, for example, a CCD with 30×30 pixels or the like, and has a resolution of 1200 dpi.

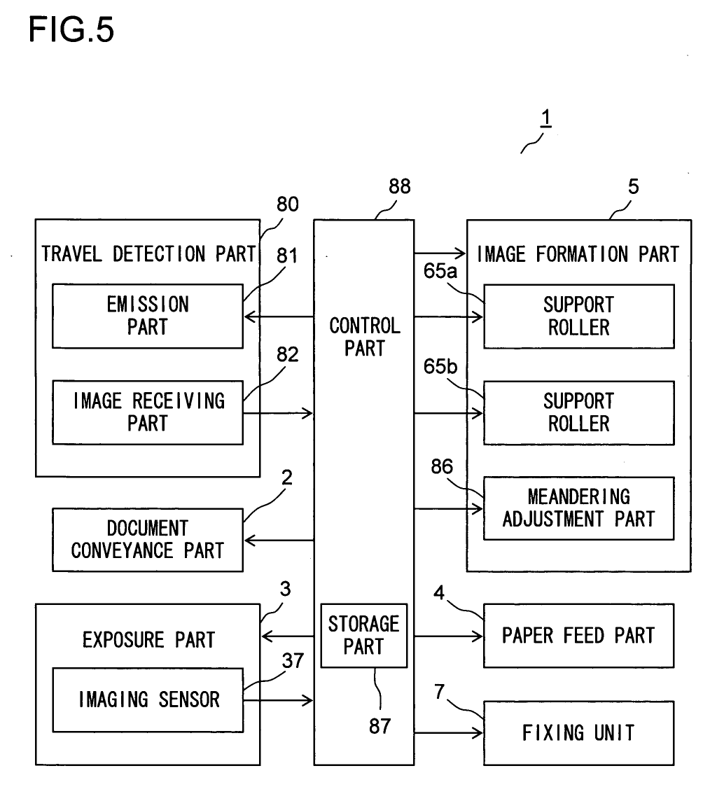

FIG. 4 is a plan view to show visual fields of the image receiving part 82 on the intermediate transfer body 61. When the intermediate transfer body 61 moves in a direction of arrow A, the visual field 83 of the image receiving part 82 moves in sequence of visual fields 83′ and 83″. As a result, for example, 5200 successive images on the intermediate transfer body 61 are obtained for one second. Data of the successive images obtained by the image receiving part 82 are transmitted to a control part 88 (see FIG. 5). The successive images are compared with each other by the control part 88, whereby displacements in X direction and Y direction as viewed in the figure are detected. An image of slight irregularity or scratch on the surface of the intermediate transfer body 61 is obtained by the image receiving part 82.

FIG. 5 is a block diagram to show a configuration of the image forming apparatus 1. The image forming apparatus 1 includes the control part 88 having a CPU for controlling various parts. In the control part 88, a storage part 87 is provided which is formed of a nonvolatile memory and a volatile memory. In the storage part 87, operation programs and various data for the image forming apparatus 1, results of calculation by the CPU, and the like are stored.

To the control part 88, various components, such as the travel detection part 80, the document conveyance part 2, the exposure part 3, the image formation part 5, the paper feed part 4, the conveyance rollers respectively provided in the fixing unit 7, and the like are connected. The control part 88 drives the emission part 81 of the travel detection part 80, and receives image data obtained by the image receiving part 82.

Further, the control part 88 controls the support rollers 65a and 65b and the meandering adjustment part 86 in the image formation part 5. By varying rotation speeds of the support rollers 65a and 65b, the moving speed of the intermediate transfer body 61 is varied. The meandering adjustment part 86 has a pressing part (not shown) for pressing the intermediate transfer body 61 in a direction perpendicular to a moving direction, and a travel position of the intermediate transfer body 61 is corrected by pressing of the pressing part. The meandering adjustment part 86 may be formed of means adapted to vary tilt of the support rollers 65a, 65b, and 65c. With this configuration, the travel position of the intermediate transfer body 61 can be corrected also.

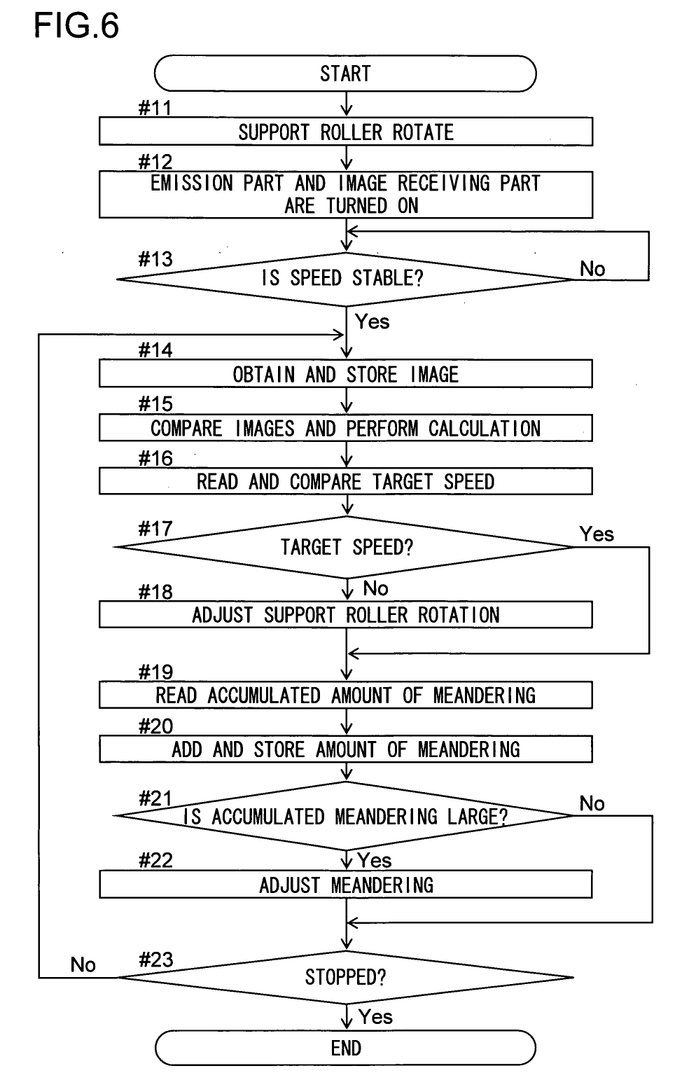

FIG. 6 is a flowchart to show operation performed by the travel detection part 80 and the control part 88 for travel adjustment of the intermediate transfer body 61. When the image forming apparatus 1 is manufactured, traveling of the intermediate transfer body 61 is adjusted into a non meandering state (hereinafter, this time point is referred to as “reference time”). A target value of the moving speed of the intermediate transfer body 61 is previously stored in the storage part 87.

When instructions for starting image formation is given, the support roller 65a is driven in steps #11, and the intermediate transfer body 61 starts to make revolving movement. In step #12, the emission part 81 and the image receiving part 82 of the travel detection part 80 are driven. In step #13, the system is held for a predetermined time until the moving speed of the intermediate transfer body 61 becomes stable. As in steps #14 to 16 to be described later, based on the successive images obtained by the image receiving part 82, it may be detected whether or not the moving speed has become stable.

In step #14, the successive images on the intermediate transfer body 61 within a predetermined sampling time are sequentially obtained by the image receiving part 82, and then stored into the storage part 87. In step #15, the successive images on the intermediate transfer body 61 are compared with one another by the control part 88, and the displacements of the intermediate transfer body 61 in the X direction and Y direction are calculated.

The moving speed (in inch/sec) of the intermediate transfer body 61 is expressed by formula (1). In the formula (1), resolution (in dpi) of the image receiving part 82 and sampling time (in sec) are constant numbers. Thus, a quotient of an amount of displacement (in dot) in the X direction by a product of the constant numbers serves as the moving speed of the intermediate transfer body 61. Therefore, the amount of displacement in the X direction as a result of the calculation in step #15 corresponds to the moving speed of the intermediate transfer body 61, thus, detecting the amount of displacement in the X direction is synonymous with detecting the moving speed.

Moving speed=Amount of displacement/(Resolution*Sampling time) (1).

In step #17, it is judged whether or not the moving speed of the intermediate transfer body 61 based on the result of the calculation in step #15 agrees with a target speed which is stored in the storage part 87 and read out in step #16. If the moving speed of the intermediate transfer body 61 agrees with the target speed, the operation proceeds to step #19. If the moving speed of the intermediate transfer body 61 does not agree with the target speed, the operation proceeds to step #18. In step #18, the rotation speed of the support roller 65a is increased or decreased by the control part 88 so at to bring the moving speed of the intermediate transfer body 61 close to the target speed.

In step #19, an accumulated amount of meandering (in dot) of the intermediate transfer body 61 is read out from the storage part 87. At the first driving from the reference time, the accumulated amount of meandering stored in the storage part 87 is 0. In step #20, the amount of displacement in the Y direction (in dot) as the result of the calculation in step #15 is added with a sign thereof identified to the accumulated amount of meandering, and then the obtained value is stored into the storage part 87. Because the amount of displacement in the Y direction is added and the accumulated amount of meandering is stored, meandering of the intermediate transfer body 61 since the reference time can easily be detected.

In step #21, it is judged whether or not the accumulated amount of meandering which is a result of addition of the amount of displacement in the Y direction exceeds a predetermined range. If the accumulated amount of meandering does not exceed the predetermined range, the operation proceeds to step #23. If the accumulated amount of meandering exceeds the predetermined range, the operation proceeds to step #22. In step #22, the meandering adjustment part 86 is driven by the control part 88, and the travel position of the intermediate transfer body 61 is corrected so as to cancel the meandering of the intermediate transfer body 61.

In step #23, it is judged whether or not instructions for stopping the image formation has been given. If the instructions for stopping the image formation has been given, the operation ends. If the instructions for stopping the image formation has not been given, steps #14 to #23 are repeated. As a result, the moving speed or the meandering of the intermediate transfer body 61 is constantly monitored and corrected. At this point, in monochrome image formation, driving of the travel detection part 80 is stopped, whereby power saving is achieved.

According to this embodiment, the moving speed or the amount of meandering of the intermediate transfer body 61 is calculated by receiving light reflected on the revolving intermediate transfer body 61 to obtain successive images and then comparing the successive images with one another, thus, the moving speed or the amount of meandering of the intermediate transfer body 61 can be detected with high accuracy. Therefore, the color shift in the circumferential direction of the intermediate transfer body 61 and in the direction perpendicular to the circumferential direction can be reliably prevented. Moreover, since the moving speed or the amount of meandering of the intermediate transfer body 61 can be detected by a single travel detection part 80 having the emission part 81 and the image receiving part 82, the cost of the image forming apparatus 1 can be reduced.

In the above described embodiment, the emission part 81 emits laser light, but may alternatively irradiate light, such as visible light provided by the LED, to the intermediate transfer body 61. However, if light emitted by the emission part 81 is laser light, a high resolution image can be obtained by the image receiving part 82. Therefore, the moving speed or the amount of meandering of the intermediate transfer body 61 can be detected with even higher accuracy.

Since a surface (transfer surface) of the intermediate transfer body 61 is formed of a gross surface without any small irregularity or the like, it is difficult in some cases to compare the successive images with one another. In this case, light may be irradiated to a rear surface of the intermediate transfer body 61 by the emission part 81, and the successive images of the rear surface of the intermediate transfer body 61 may be obtained by the image receiving part 82. As a result, the successive images can be easily compared with one another to accurately detect the moving speed or the amount of meandering.

An irregular pattern may be formed at a portion of the intermediate transfer body 61 which is not facing the recording sheet, then an image of this pattern may be obtained by the image receiving part 82. This pattern may be formed of a toner image. Further, a toner image which is transferred onto the recording sheet P may be obtained by the image receiving part 82 to compare the successive images with one another. If the front and rear surfaces of the intermediate transfer body 61 are formed of a gross surface, a pattern or the like can be formed on either one of the surfaces to improve the visibility of meandering.

In this embodiment, a toner image on the photoconductive drum 51 is transferred onto the intermediate transfer body 61 formed of an endless belt. Alternatively, the image forming apparatus may be of a type that transfers the toner image directly from the photoconductive drum 51 onto the recording sheet P which is conveyed by the endless belt. At this moment, the moving speed or the meandering of the endless belt conveying the recording sheet P can be detected by the travel detection part 80. As a result, similar to the above description, the color shift upon superimposing the toner images of a plurality of colors on one another can be reduced.

The image forming apparatus 1 is formed of a color copier, but may be an image forming apparatus of a different type, such as a printer, a facsimile, or the like. That is, the same effect can be provided in an image forming apparatus that forms a color image by transferring the toner images of a plurality of colors from the photoconductive drums 51.

Further, the travel detection part 80 and the control part 88 form the control device that controls a speed of the revolving endless belt. Thus, not only a moving speed of the endless belt provided in the image forming apparatus 1 but also the moving speed or meandering of a revolving endless belt loaded in a different apparatus can be detected by the control device with high accuracy.

The present invention is applicable to apparatus provided with a revolving endless belt such as image forming apparatus or the like.

What is claimed is:

1. An image forming apparatus comprising:
a revolving endless belt sequentially superimposing and transferring toner images formed on a plurality of photoconductive drums directly thereon or onto a recording sheet conveyed thereby;
an emission part irradiating light to the endless belt;
an image receiving part receiving light reflected on the endless belt to obtain successive images of the endless belt; and
a control part comparing the successive images obtained by the image receiving part with one another, calculating either of a moving speed and an amount of meandering of the endless belt, and correcting either of the moving speed and the meandering of the endless belt based on a result of the calculation.

2. The image forming apparatus according to claim 1 wherein the light emitted by the mission part is laser light.

3. The image forming apparatus according to claim 1 further comprising a storage part storing an amount of meandering accumulated from a reference time at which the endless belt is adjusted into a non meandering state, wherein the meandering of the endless belt is corrected when the accumulated amount of meandering exceeds a predetermined value.

4. The image forming apparatus according to claim 1 wherein a rear surface of the endless belt is irradiated with the light by the emission light and the successive images of the rear surface of the endless belt are obtained by the image receiving part.

5. A control device for controlling either of a speed and meandering of an object to be measured, the control device comprising:
an emission part emitting light to a revolving endless object to be measured;
an image receiving part receiving light reflected on the object to be measured to obtain successive images of the object to be measured; and
a control part comparing the successive images obtained by the image receiving part with one another, calculating either of a moving speed and an amount of the meandering of the object to be measured, and correcting either of the moving speed and the meandering of the object to be measured based on a result of the calculation.

6. The control device according to claim 5 wherein the light emitted by the emission part is laser light.

7. The control device according to claim 5 further comprising a storage part storing an amount of meandering accumulated from a reference time at which the object to be measured is adjusted into a non meandering state wherein the meandering of the object to be measured is corrected when the accumulated amount of meandering exceeds a predetermined value,
